(19) United States
(12) Patent Application Publication
(10) Pub. No.: US 2017/0178149 A1
(43) Pub. Date: Jun. 22, 2017

(54) METHOD AND SYSTEM FOR PURCHASE PATTERN EXTRACTION FROM POINT OF SALE DATA

(71) Applicant: INTERNATIONAL BUSINESS MACHINES CORPORATION, Armonk, NY (US)

(72) Inventors: Tetsuro Morimura, Tokyo (JP); Kazunori Shimazu, Tokyo (JP); Noppharit Tongprasit, Bangkok (TH)

(21) Appl. No.: 14/971,533

(22) Filed: Dec. 16, 2015

(51) Int. Cl. G06Q 30/02; G06Q 20/20

(52) U.S. Cl. CPC G06Q 30/0201; G06Q 20/20

(57) ABSTRACT

The method generating a point of sale data matrix from a purchase record, the point of sale data matrix including buying information of each item and purchase quantity information of each item, extracting purchase patterns from the point of sale data matrix using a matrix factorization method to provide a maximum score value, the maximum score value representing the purchase patterns, identifying related factors associated with each of the purchase patterns to provide a related factor model, and testing at least one simulated related factor in a simulated environment based on the related factor model to determine a difference in purchase patterns.

### BACKGROUND

Technical Field

The present invention generally relates to purchase pattern extraction, and more particularly to identifying related factors in purchase patterns in Point of Sale data.

Description of the Related Art

Point of sale is generally referred to as time and location information where a retail transaction occurs between a merchant and a customer. Point of sale data may be collected by point of sale software, which is typically used in conjunction with cash registers and/or inventory systems, to provide a customer with a receipt of purchase and/or purchase record (e.g., an invoice). The receipt of purchase and/or purchase record, which may be in paper or electronic form, generally includes a list of purchased items, quantity of items, and may include miscellaneous information, such as time and location, method of purchase, description of goods and/or services provided, etc. While the point of sale data includes general information of the purchases made, identifying purchase patterns for demand chain management (DCM) remains a challenge for merchants.

Consolidation of large scale point of sale data based on stock keeping unit (SKU) numbers and/or conventional category levels typically requires an enormous amount of memory and calculations, since each SKU number must be known and consolidation of the point of sale data results in an excessive number of purchases and/or fails to identify characteristics related to the purchase patterns. For example, consolidating point of sale data based on SKU numbers includes extraneous purchase information, such as impulse purchases, which causes noise in a purchase pattern. As a result, the problem of identifying related factors associated with purchase patterns is not addressed.

### SUMMARY

In accordance with the present principles, a method for identifying related factors of purchase patterns for point of sale data is provided. The method includes generating a point of sale data matrix from at least one purchase record, the point of sale data matrix including at least buying information of each item and purchase quantity information of each item, extracting purchase patterns from the point of sale data matrix using a matrix factorization method to provide a maximum score value, the maximum score value representing the purchase patterns, identifying related factors associated with each of the purchase patterns to provide a related factor model, and testing at least one simulated related factor in a simulated environment based on the related factor model to determine a difference in purchase patterns

According to another aspect of the present principles, a processor-based monitoring device having at least a processor and a memory device for identifying related factors of purchase patterns in point of sale data is provided. The monitoring device includes a matrix generator to generate a point of sale data matrix from at least one purchase record, the point of sale data matrix including at least buying information of each item and purchase quantity information of each item, a pattern extractor to extract purchase patterns from the point of sale data matrix using a matrix factorization method to provide a maximum score value, the maximum score value representing the purchase patterns, a related factor identifier to identify related factors associated with each of the purchase patterns to provide a related factor model, and a pattern estimation unit to test at least one simulated related factor in a simulated environment based on the related factor model to determine a difference in purchase patterns.

According to another aspect of the present principles, a non-transitory computer readable storage medium for identifying related factors of purchase patterns for point of sale data is provided. The non-transitory computer readable storage medium includes a computer readable program for identifying related factors of purchase patterns for point of sale data, wherein the computer readable program, when executed on a computer, causes the computer to perform the steps of generating, by a processor-based monitoring device, a point of sale data matrix from at least one purchase record, the point of sale data matrix including at least buying information of each item and purchase quantity information of each item, extracting purchase patterns from the point of sale data matrix using a matrix factorization method to provide a maximum score value, the maximum score value representing the purchase patterns, identifying related factors associated with each of the purchase patterns to provide a related factor model, and testing at least one simulated related factor in a simulated environment based on the related factor model to determine a difference in purchase patterns.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 shows an exemplary processing method/system for identifying related factors of purchase patterns for point of sale data, in accordance with an embodiment of the present principles;

FIG. 2 shows an exemplary illustration of a standard deviation of the point of sale data, in accordance with an embodiment of the present principles;

FIG. 3 shows an exemplary illustration of a standard deviation of the point of sale data, in accordance with an embodiment of the present principles; and

FIG. 4 is a block/flow diagram illustrating an exemplary method/system for identifying related factors of purchase patterns for point of sale data, in accordance with an embodiment of the present principles.

### DETAILED DESCRIPTION

In accordance with the present principles, a system and method is provided for identifying related factors of purchase patterns for point of sale data. In an embodiment, purchase patterns may be extracted and related factors associated with the purchase patterns may be identified. According to one embodiment, the related factors and/or purchase patterns (PP) may include information related to, for example, motivation behind purchasing tendencies, including types of items purchased, time of purchase, location of purchase, population density, etc. The present principles may provide at least one of the following advantages, namely, identifying related factors associated with purchase patterns to increase effectiveness of marketing activities and/or to increase efficiency of demand chain management (DCM). DCM is referred to as a method for optimizing product-development, production, and distribution based on purchase behaviors of customers, including cost and demand factors.

It also should be understood that the present invention will be described in terms of customers and merchants of the retail industry; however, the teachings of the present invention are much broader and are applicable to any industry, including service industries. In addition, the terms “merchant” and “customer” are used loosely and are not intended to suggest any limitation as to the scope of use or functionality of embodiments of the present principles described herein. For example, “merchant” may refer to, but is not limited to, a retail business, however, other businesses and/or industries are contemplated, including the restaurant industry, the hospital industry, and/or the hospitality industry (e.g., hotels, motels, etc.). Generally, the word “customer” refers to a purchaser of the merchant's goods and/or services, but may include a client, a patient, etc., and is not intended to limit the present principles.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

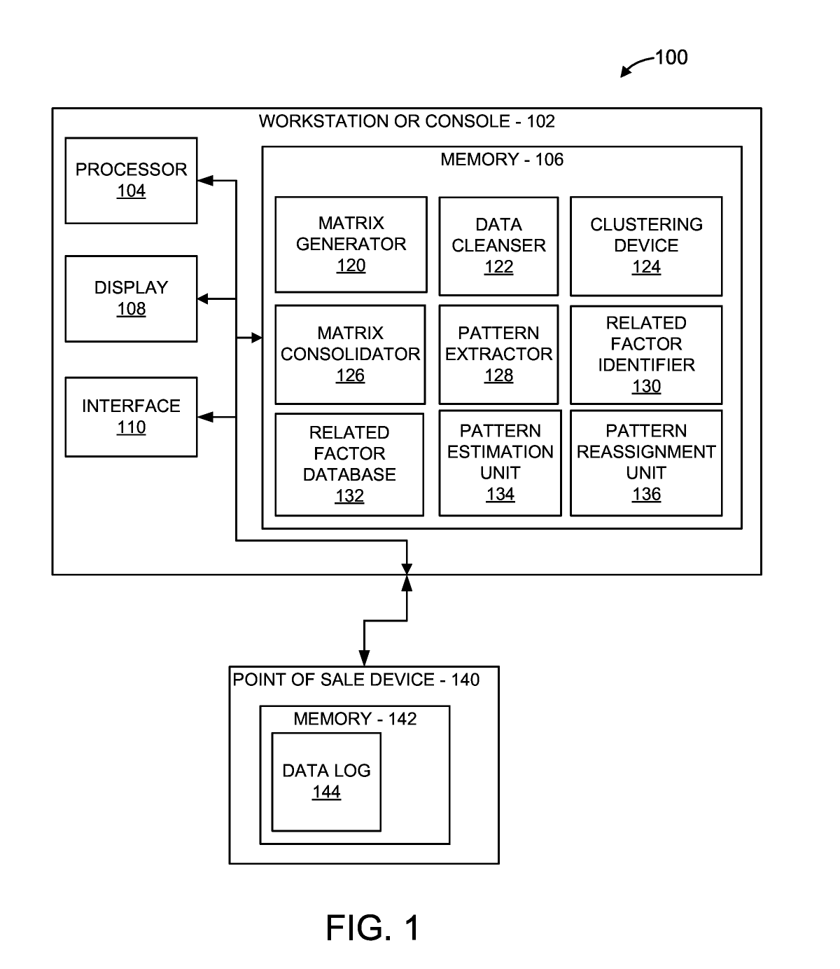

Referring to the drawings in which like numerals represent the same or similar elements and initially to FIG. 1, a system 100 for identifying related factors of purchase patterns from point of sale data is illustratively depicted in accordance with one embodiment. System 100 may include a workstation or console 102 from which a procedure is supervised and/or managed. Workstation 102 preferably includes one or more processors 104 and memory 106 for storing programs and applications. Memory 106 may store a matrix generator 120, data cleanser 122, a clustering device 124, a matrix consolidator 126, a pattern extractor 128, a related factor identifier 130, and a related factor database 132.

In one embodiment, workstation 102 is configured to receive data from a point of sale device 140 and/or any element of the point of sale device 140. For example, the workstation 102 may be configured to receive data from a point of sale data log 144, which may include various point of sale data information, which may be stored in memory 142 in the point of sale device 140. The point of sale device 140 may include, but is not limited to, a cash register, a payment terminal (e.g., a credit card terminal, an electronic funds transfer terminal, etc.), an inventory device, tablet point of sale systems and/or similarly functioning devices and may be able to communicate with the workstation 102 wirelessly or in a hardwired manner. In an alternate embodiment, the workstation or console 102 and/or memory 106 may be included in the point of sale device 140.

In an embodiment, the point of sale data log 144 may store information of each purchase made by a customer, such as receipts and/or purchase records which may include information related to the items purchased, the amount of each item purchased, the location of the transaction, the time of the transaction, etc. In another embodiment, the point of sale data log 144 may store electronic copies of a plurality of receipts from payment transactions. In a further embodiment, the point of sale data log 144 may exclude certain personal information of a customer to ensure the privacy and safeguarding of such personal information, such as name of the customer, address of the customer, credit card and/or bank account numbers of the customer, etc.

The purchase patterns and/or the related factors associated with the purchase patterns may be displayed on a display device, such as display device 108. Workstation 102 includes the display device 108 for viewing the point of sale data information, the purchase patterns and/or the related factors associated with the purchase patterns to enable the user to, for example, increase effectiveness of demand chain management. Display device 108 may also permit a user to interact with the workstation 102 and its components and functions, or any other element within the system 100. This may be further facilitated by an interface 110, which may include a keyboard, mouse, a joystick, a haptic device, or any other peripheral or control to permit user feedback from and interaction with the workstation 102.

A matrix generator 120 is stored in memory 106 and is configured to generate a point of sale data matrix. In an embodiment, the matrix generator 120 may generate the point of sale data matrix based on the point of data information stored in data log 144 in the point of sale device 140. For example, the matrix generator 120 may generate a point of sale data matrix based on the information provided on receipts and/or purchase records stored in data log 144. As described above, the point of sale data log 144 may exclude personal information of the customer. In an embodiment, the point of sale data may include information included on a printed and/or electronic receipt after a customer makes a purchase. In an embodiment, the matrix generator 120 may be configured to extract the point of sale data from the data log 144 of the point of sale device 140 and generate a point of sale data matrix. The point of sale data matrix may include rows and columns, wherein the rows include buying information for each item (e.g., name of product, type of product, etc.) and the columns include purchase quantity information for each item (e.g., the amount of items purchased for each item listed in each row).

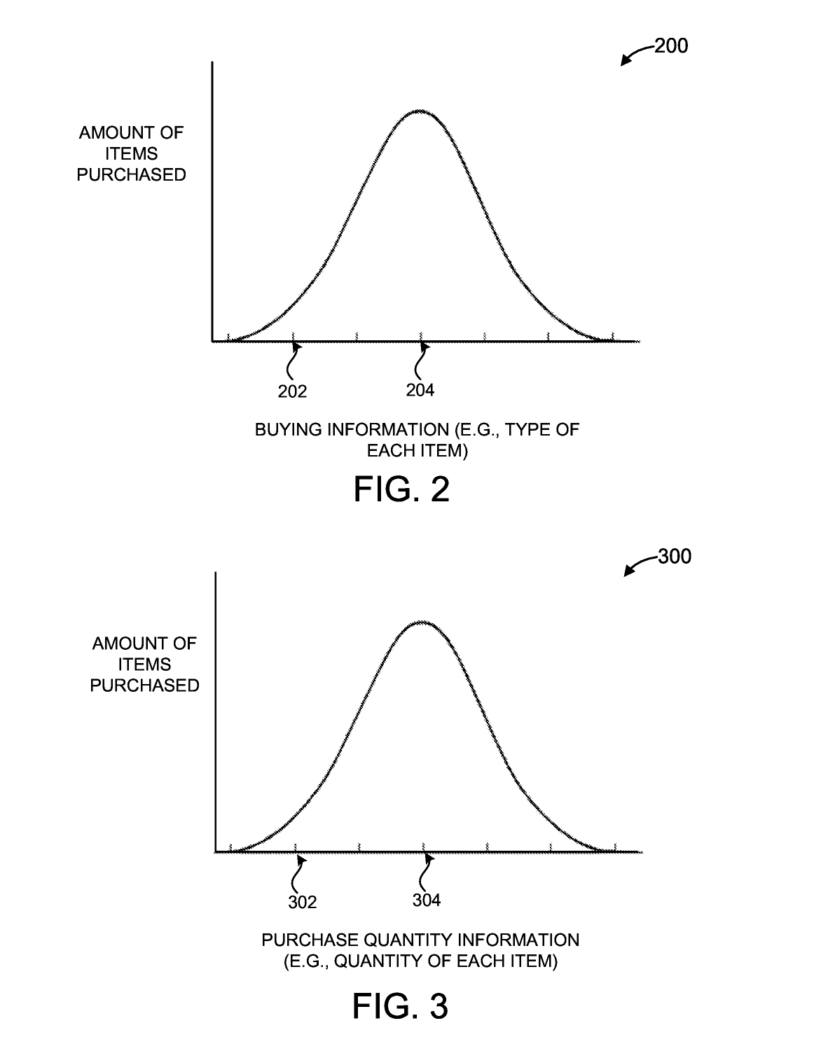

The data cleanser 122 may be configured to scale the point of sale data matrix to generate a standard deviation of the point of sale data matrix. In an embodiment, the data cleanser 122 may generate the standard deviation to provide consolidated data of the point of sale data matrix. A standard deviation is a measure that is used to quantify the amount of variation of a set of data values. In an embodiment, the set of data values may include, but is not limited to, type of item, quantity of item, etc. For example, the standard deviation of the point of sale data matrix may quantify either the buying information (e.g., rows), the purchase quantity information (e.g., columns), or combination thereof. Exemplary illustrations of the standard deviation will be described in further detail with reference to FIGS. 2 and 3.

The clustering device 124 may be configured to itemize information in the point of sale data matrix to assign items to same and/or similar item groups and to consolidate the point of sale data matrix to provide consolidated data. For example, similar items groups may include items that are distinguished by item type (e.g., food, toy, clothing, medicine, etc.). In an embodiment, the clustering device 124 may reduce the number of rows of the point of sale data matrix by clustering the buying information into similar item groups. For example, when a receipt and/or purchase record includes bread, milk, water, shirt, and pants, the clustering device 124 may assign bread, milk, and water to a first similar item group, such as “food”, and may assign shirt and pants to a second similar item group, such as “clothing”. The clustering device 124 may employ a dimension reduction method, such as singular value decomposition (SVD), k-means clustering, and/or any other type of clustering method to reduce the information included in the point of sale data matrix and/or cluster each item into similar items groups.

The matrix consolidator 126 may be configured to reduce the purchase quantity information (e.g., columns) to provide consolidated data. In an embodiment, the matrix consolidator 126 may reduce the purchase quantity information by merging the columns for items assigned to a similar item group. For example, when the clustering device 124 groups items into a similar item group, the matrix consolidator 126 may merge the purchase quantity information (e.g., the amount of each item) for the similar item group. In an embodiment, the matrix consolidator 126 may merge and/or combine the quantity of items that are associated with the same/similar item group by, for example, summation methods (e.g., addition of the quantity of each item in the similar item group).

The pattern extractor 128 may be configured to extract purchase patterns based on the point of sale data matrix and/or the consolidated data. Purchase patterns may include, but are not limited to, types of items purchased, quantity of items purchased, etc. In an embodiment, the pattern extractor 128 may extract purchase patterns by factorizing the data matrix and/or the consolidated data using a matrix factorization method to provide a maximum score value, the maximum score value representing purchase patterns. For example, the matrix factorization method may include, but is not limited to, a non-negative matrix factorization (NMF) method, a singular value decomposition (SVD) method, etc. Accordingly, factorization of the data matrix and/or consolidated data results in the maximum score value representing purchase patterns which is much easier and efficient to inspect and/or analyze. In one embodiment, the factorization with the highest maximum score value may represent the purchase pattern with the highest pattern. In an embodiment, the amount of purchase patterns may include a minimum number of purchase patterns to ensure an adequate pool of information. For example, if the amount of purchase patterns in less than five, a representation of the population purchasing from the merchant may not be adequately provided.

The related factor identifier 130 may be configured to identify related factors associated with each of the purchase patterns to increase effectiveness of the demand chain management (DCM). The related factors may include, but are not limited to, time of purchase, date of purchase, merchant/shop information (e.g., size of shop, location of merchant, layout of shop, etc.) and/or profiler indicators (e.g., consumption amount and/or pattern of customer, types of items purchased, method of travel to merchant, commitment to health, approximate number of persons in household of customer, population density, approximated household income, structure of household (such as children versus no children), etc.). For example, when the purchase pattern indicates the purchase of low-calorie items (e.g., a high maximum score of low-calorie items), the profiler indicator may indicate a commitment to health. In another example, when the purchase pattern indicates a bulk purchase pattern, the profiler indicator may indicate an approximate number of persons in a household (e.g., such as a large household purchasing bulk items).

In one embodiment, once the related factors are identified by the related factor identifier 130, the strength of the purchase patterns may be controlled by adjusting the related factors. For example, in marketing applications and/or store development, adjusting the strength of each purchase pattern may be increased by store-branding and/or sales. In a further embodiment, the related factors associated with the purchase patterns may be used to provide a related factor model, which may be generated by the related factor identifier 130. The related factor model may be stored, for example, in the related factor database 132 and may be accessed by a user through the interface 110 and/or display 108.

In a further embodiment, the related factor model may be provided to the pattern estimation unit 134. The pattern estimation unit 134 may be configured to determine a difference in purchase patterns (e.g., increase/decrease in purchase patterns) when at least one simulated related factor is tested in a simulated environment. For example, when a related factor associated with a purchase pattern is identified, such as store location, a simulated related factor (e.g., new store location) may be tested in a simulated environment by the pattern estimation unit 134 to determine whether a difference in purchase patterns occurs (e.g., increase/decrease in purchase patterns).

In another example, if the related factor indicates a commitment to health, a simulated related factor may include providing a health food previously not sold, to determine whether the new health food provides a difference in the purchase patterns in a simulated environment. If the purchase pattern increases, inclusion of the new health food in the merchant's inventory would be advantageous. In an embodiment, the system 100 may include a pattern reassignment unit 136 such that when a difference in the purchase patterns occurs (e.g., increase in sales), the pattern reassignment unit 136 may add the simulated related factor (e.g., new food item) to the merchant's inventory and/or item order list (e.g., recorder list). For example, the pattern reassignment unit 136 may add the simulated new item to an order list (not shown), which may be stored in memory 106, for the merchant to order the new item. The simulated related factor may include, but is not limited to, alternate store location, alternate store layout, alternate store hours of operation, marketing/advertisement increase (e.g., selective marketing based on purchase patterns and/or related factors), additional transportation means (e.g., addition of a bus route, train route, etc.), alternate sale items (e.g., providing items previously not sold), etc.

In an embodiment, the related factor identifier 130 may identify related factors using a regression analysis with a linear model method, a tree model method, etc. For example, a regression analysis with linear model method may model the relationship between an objective variable (e.g., number of receipts×number of purchase patterns) and one or more explanatory variables, such as potential reasons for variation (e.g., number of receipts×number of receipt features). Accordingly, a feature that has a large coefficient value is a stronger related factor to the purchase pattern. The relationship between purchase patterns and related factors may be observed using the regression tree.

The related factor database 132 may be configured to store the related factors associated with each of the purchase patterns. In an embodiment, the related factor database 132 may be configured to provide an index of related factors and/or associated purchase patterns. In an embodiment, the related factors associated with the purchase patterns may be employed to increase effectiveness of demand chain management (DCM). For example, DCM may include at least one of the following: modifying store characteristics based on the purchase patterns, increase the effectiveness of marking activities by exploiting the relationship between related factors and purchase patterns, controlling the purchase patterns of customers by regulating the related factors, or combination thereof. In addition, the system for identifying related factors of purchase patterns may improve computation efficiency and/or reduce computation latencies by, for example, generating a consolidated data matrix. The present invention may improve the computation performance and quality of the computation.

Referring now to FIG. 2 and FIG. 3, exemplary illustrations of the standard deviation to provide consolidated data are shown. In FIG. 2, a standard deviation 200 of the point of sale data matrix is shown where the quantification of the amount of variation is based on the buying information, such as the type of each item. For example, type of item may include a toy related item 202 whereas type of item may include a food related item 204. Accordingly, in the example shown in FIG. 2, the standard deviation 200 (e.g., the amount of items purchased) is much higher for food related items 204 than that of toy related items 202.

In FIG. 3, a standard deviation 300 of the point of sale data matrix is shown where the quantification of the amount of variation is based on the purchase quantity information, such as the quantity of each item. For example, the standard deviation 300 may illustrate that the purchase quantity for food related items 304 is much higher than the purchase quantity for toy related items 302.

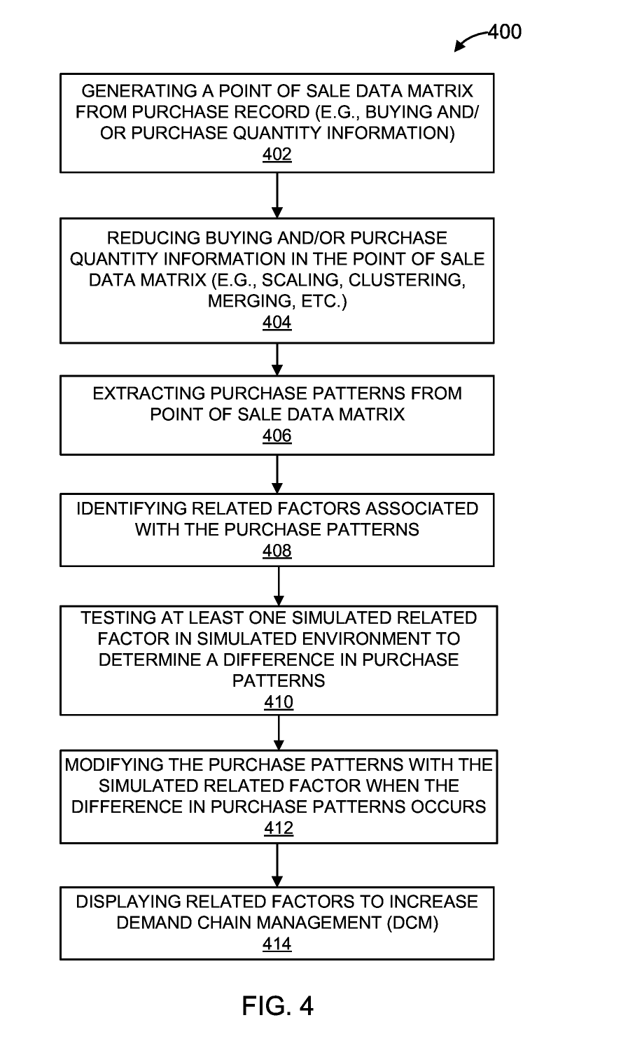

Now referring to FIG. 4, an exemplary method 400 for identifying related factors of purchase patterns is illustratively depicted.

In block 402, the method 400 may include generating a point of sale data matrix from point of sale data. For example, generating the point of sale data matrix may include extracting purchase information from at least one purchase record. As described above, the purchase record may include invoices, receipts, etc. The point of sale data matrix may include any number of rows and columns. In an embodiment, the rows may include buying information for each item (e.g., name of product, type of product, etc.) and the columns may include purchase quantity information for each item (e.g., the amount of items purchased for each item listed in each row).

In block 404, the method may include reducing information included in the point of sale data matrix to provide consolidated information of the at least one purchase. In one embodiment, reducing the information in the point of sale data matrix may include scaling the point of sale data matrix to determine a standard deviation. In another embodiment, reducing the information in the point of sale data matrix may include clustering the information provided in point of sale data matrix to provide similar item groups (e.g., based on buying information of each item). In a further embodiment, reducing the information in the point of sale data matrix may include merging the purchase quantity information for items clustered in a similar item group.

In block 406, the method 400 may include extracting purchase patterns from the point of sale data matrix. For example, extracting purchase patterns may include a factorization method (e.g., NMF, SVD, etc.)

In block 408, the method 400 may include identifying related factors associated with the purchase patterns to provide a related factor model. The related factors may include time of purchase, date of purchase, merchant/shop information (e.g., size of shop, location of merchant, layout of shop, etc.) and/or profiler indicators (e.g., consumption amount and/or pattern of customer, types of items purchased, method of travel to merchant, commitment to health, approximate number of persons in household of customer, population density, approximated household income, structure of household (such as children versus no children), etc.).

In block 410, the method 400 may include testing at least one simulated related factor in a simulated environment based on the related factor model to determine a difference in purchase patterns. For example, when a related factor associated with a purchase pattern is identified, a simulated related factor may be tested in a simulated environment by, for example, the pattern estimation unit 134 of FIG. 1 to determine whether a difference in purchase patterns occurs (e.g., increase/decrease in purchase patterns). When the difference in purchase patterns occurs, the method 400 may further include modifying the purchase patterns with the least one simulated related factor, as illustrated in block 412. The simulated related factor may include, but is not limited to, alternate store location, alternate store layout, marketing/advertisement increase (e.g., selective marketing based on purchase patterns and/or related factors), additional transportation means (e.g., addition of a bus route, train route, etc.), alternate sale items (e.g., providing items previously not sold), etc.

In block 414, the method 400 may include displaying the related factors to a user by, for example, a display device to increase demand chain management. For example, displaying related factors may include displaying the related factors to a user via workstation 102 and/or display 108 of FIG. 1.

Having described preferred embodiments for identifying related factors of purchase patterns from a point of sale data matrix (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for identifying related factors of purchase patterns in point of sale data, comprising:
generating a point of sale data matrix from at least one purchase record, the point of sale data matrix including at least buying information of each item and purchase quantity information of each item;
extracting purchase patterns from the point of sale data matrix using a matrix factorization method to provide a maximum score value, the maximum score value representing the purchase patterns;
identifying related factors associated with each of the purchase patterns to provide a related factor model; and
testing at least one simulated related factor in a simulated environment based on the related factor model to determine a difference in purchase patterns.

2. The method of claim 1, further comprising modifying the purchase patterns with the least one simulated related factor when the difference in purchase patterns occurs.

3. The method of claim 1, further comprising displaying the related factors to a user to increase the effectiveness of demand chain management.

4. The method of claim 1, further comprising reducing at least one of the buying information and/or purchase quantity information.

5. The method of claim 4, wherein reducing the at least one of the buying information and/or the purchase quantity information includes scaling the point of sale data matrix to provide a standard deviation of the point of sale data matrix, wherein the standard deviation quantifies the at least one of the buying information and/or the purchase quantity information.

6. The method of claim 4, wherein reducing the buying information includes clustering items from the at least one purchase record into similar item groups using at least one of a clustering method and/or a dimension reduction method.

7. The method of claim 6, wherein reducing the purchase quantity information includes merging the purchase quantity information for each item assigned to a similar item group.

8. The method of claim 1, wherein the matrix factorization method includes at least one of a non-negative matrix factorization method, a singular value decomposition method, or a combination thereof.

9. The method of claim 1, wherein the related factors includes at least one of time of purchase information, date of purchase information, merchant information, profile indicators, or a combination thereof.

10. The method of claim 9, wherein the profile indicators include at least one of consumption amount, type of purchased item, method of travel, commitment to health, number of persons in household, structure of household, population density, or a combination thereof.

11. A processor-based monitoring device having at least a processor and a memory device for identifying related factors of purchase patterns in point of sale data, comprising:
a matrix generator to generate a point of sale data matrix from at least one purchase record, the point of sale data matrix including at least buying information of each item and purchase quantity information of each item;
a pattern extractor to extract purchase patterns from the point of sale data matrix using a matrix factorization method to provide a maximum score value, the maximum score value representing the purchase patterns;
a related factor identifier to identify related factors associated with each of the purchase patterns to provide a related factor model; and
a pattern estimation unit to test at least one simulated related factor in a simulated environment based on the related factor model to determine a difference in purchase patterns.

12. The monitoring device of claim 11, further comprising a pattern reassignment unit configured to modify the purchase patterns with the least one simulated related factor when the difference in purchase patterns occurs.

13. The monitoring device of claim 11, further comprising a display device to display the related factors to a user increase the effectiveness of demand chain management.

14. The monitoring device of claim 11, further comprising a data cleanser configured to reduce at least one of the buying information and/or the purchase quantity information by scaling the point of sale data matrix to provide a standard deviation of the point of sale data matrix, wherein the standard deviation quantifies the at least one of the buying information and/or the purchase quantity information.

15. The monitoring device of claim 11, further comprising a clustering device configured to reduce the buying information by clustering items from the at least one purchase record into similar item groups using at least one of a clustering method and/or a dimension reduction method.

16. The monitoring device of claim 15, further comprising a matrix consolidator configured to reduce the purchase quantity information by merging the purchase quantity information for each item assigned to a similar item group

17. A non-transitory computer readable storage medium comprising a computer readable program for identifying related factors of purchase patterns in point of sale data, wherein the computer readable program, when executed on a computer, causes the computer to perform the steps of:
generating, by a processor-based monitoring device, a point of sale data matrix from at least one purchase record, the point of sale data matrix including at least buying information of each item and purchase quantity information of each item;
extracting purchase patterns from the point of sale data matrix using a matrix factorization method to provide a maximum score value, the maximum score value representing the purchase patterns;
identifying related factors associated with each of the purchase patterns to provide a related factor model; and
testing at least one simulated related factor in a simulated environment based on the related factor model to determine a difference in purchase patterns.

18. The non-transitory computer readable storage medium of claim 16, the method further comprising modifying the purchase patterns with the least one simulated related factor when the difference in purchase patterns occurs.

19. The non-transitory computer readable storage medium of claim 16, the method further comprising displaying the related factors to a user to increase the effectiveness of demand chain management.

20. The non-transitory computer readable storage medium of claim 16, the method further comprising reducing at least one of the buying information and/or purchase quantity information.
